(19) United States
(12) Patent Application Publication
(10) Pub. No.: US 2015/0039150 A1
(43) Pub. Date: Feb. 5, 2015

(54) HUB AND POWER MANAGEMENT METHOD THEREOF

(71) Applicant: GOOD WAY TECHNOLOGY CO., LTD., NEW TAIPEI CITY (TW)

(72) Inventor: YING-HAO LIN, NEW TAIPEI CITY (TW)

(73) Assignee: GOOD WAY TECHNOLOGY CO., LTD., New Taipei City (TW)

(21) Appl. No.: 13/953,810

(22) Filed: Jul. 30, 2013

(51) Int. Cl. G05B 15/02

(52) U.S. Cl. CPC G05B 15/02
USPC 700/297

(57) ABSTRACT

A hub includes a plurality of connecting modules and a processing unit. Each connecting module includes an input port, a switch unit and a measuring unit. The input port has a power terminal and a data terminal. The power terminal is connected to a power supply unit to receive electric power; the data terminal is connected to a server to transmit data. The switch unit is connected to the power terminal and at least one electronic device for changing a short circuit status or an OFF status between input and output terminals through a control signal. The measuring unit measures the intensity of a current outputted from the power terminal and generates a measure signal corresponding to the current intensity. The processing unit executes an algorithm to calculate the measure signal, generates the control signal corresponding to the measure signal, and transmits the control signal to the switch unit.

### FIELD OF TECHNOLOGY

The present invention relates to the technical field of power management, in particular to a hub with a smart power management and a power management method applied to the hub.

### BACKGROUND

In the prior art, a single port is expanded to a plurality of ports by using a hub, so that electric power and data can be transmitted among a plurality of electronic devices (such as a portable mobile device, a mouse, a keyboard or a power bank) simultaneously. For the transmission of electric power, an electric power in compliance with a communication port protocol can be outputted from each of the ports according to the communication port protocol.

In fact, a power supply connected to the hub should be taken into consideration to determine whether or not each of the ports can output an electric power in compliance with the communication port protocol. If the power supply supplies sufficient electric power, then each of the ports will be able to comply with the communication port protocol, or else only some of the ports will be able to comply with the communication port protocol.

To allow each of the ports to meet the power requirement of the communication port protocol, the power supply with a sufficient supply of electric power should be connected, but the power supply not only incurs a high cost, but also comes with a large size. Therefore, the power supply usually fails to supply sufficient electric power.

However, the electronic devices are not necessary to have an electric power as specified by the standard protocol. If an unnecessary power is supplied to each of the electronic devices, a waste of energy will be resulted. For example, the power consumption of a mouse is obviously lower than the power consumption of the portable mobile device. Therefore, it is an important issue to have an effective power management of the electric power in the hub.

### SUMMARY

Therefore, it is a primary objective of the present invention to provide a hub that allocates limited electric power of the power supply unit to be supplied to a plurality of electronic devices to achieve the power saving effect.

A second objective of the present invention is to record the sequence of the electronic devices connected to the hub and supply the electric power to one of the electronic devices that is connected to the hub first.

A third objective of the present invention is to provide a power management method applied to a hub, so that the hub can supply the electric power of the power supply unit for a smart power management.

To achieve the aforementioned and other objectives, the present invention provides a hub connected to a power supply unit, a server and at least one electronic device, and the hub comprises a plurality of connecting modules and a processing unit. Each of the connecting modules comprises an input port, a switch unit and a measuring unit. The input port has a power terminal and a data terminal. The power terminal is connected to the power supply unit for receiving electric power, and the data terminal is connected to the server for transmitting data. The switch unit has an input terminal, a control terminal and an output terminal. The input terminal is connected to the power terminal The control terminal receives a control signal to change a short circuit status or an OFF status between the input terminal and the output terminal. The measuring unit is connected to the power terminal The measuring unit is provided for measuring the circuit intensity of a current outputted from the power terminal to generate a measure signal corresponding to the current intensity. The processing unit is connected to the measuring unit and the control terminal of each of the connecting modules. The processing unit is provided for receiving the measure signal of each of the connecting modules. The processing unit executes an algorithm to compute the measure signal of each of the connecting modules, such that the processing unit can generate the control signal corresponding to the measure signal and transmit the control signal to the control terminal

To achieve the aforementioned and other objectives, the present invention provides a power management method applied to a hub. The hub is connected to a power supply unit and a first electronic device. The power supply unit has a constant voltage and a maximum output voltage. The hub comprises a first input port, a second input port, a first switch unit, a second switch unit, a first measuring unit, a second measuring unit and a processing unit. Each of the first input port and the second input port is connected to the power supply unit. The first switch unit is connected to the first input port and the first electronic device. The second switch unit is connected to the second input port. The first measuring unit is connected to the first input port and the processing unit. The second measuring unit is connected to the second input port and the processing unit. The power management method comprises the following steps. Step (a): The first measuring unit measures the current intensity of a first current outputted from the first input port, and the second measuring unit measures the current intensity of a second current outputted from the second input port to confirm that the first switch unit is connected to the first electronic device and the second switch unit is not connected to the second electronic device. Step (b): The first measuring unit generates a first measure signal according to the current intensity of the first current, and the first measuring unit transmits the first measure signal to the processing unit. The first measure signal includes the current intensity of the first current. Step (c): The processing unit executes an algorithm to compute the current intensity of the first current of the first measure signal to generate a first control signal and operate the first switch unit, and the first switch unit drives the power supply unit to supply at least a portion of electric power to the first electronic device or not to supply any electric power to the first electronic device according to the first control signal.

### BRIEF DESCRIPTION

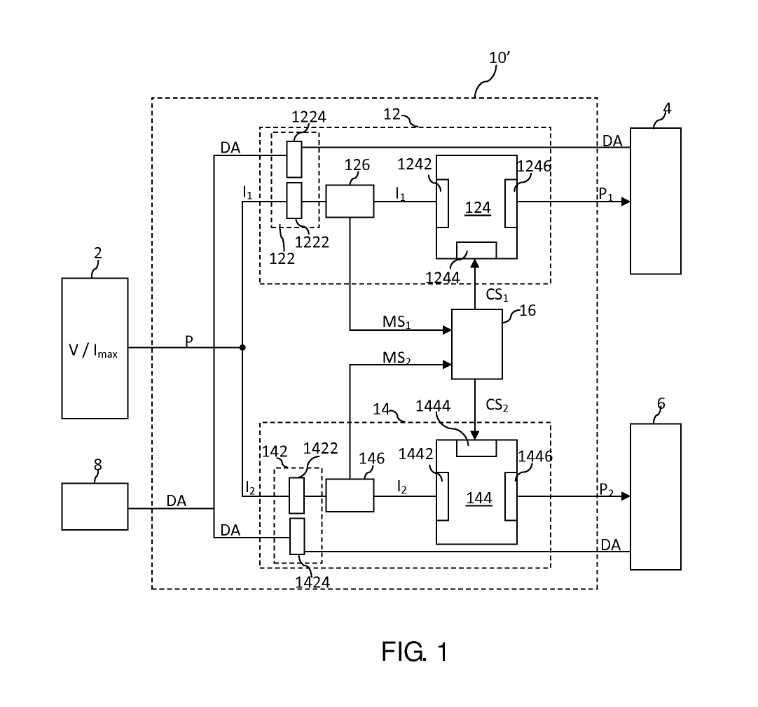

FIG. 1 is a schematic block diagram of a hub in accordance with a first preferred embodiment of the present invention;

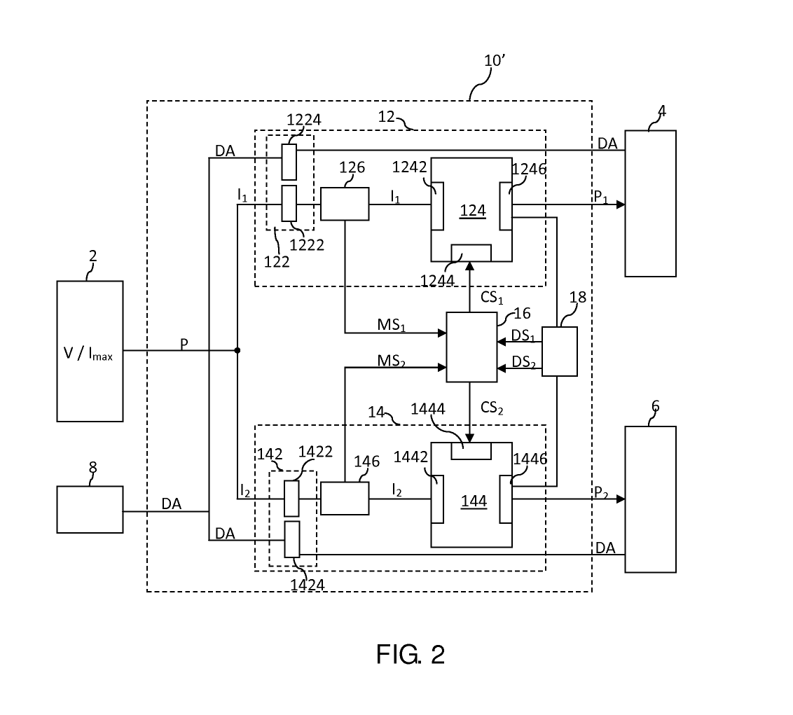

FIG. 2 is a schematic block diagram of a hub in accordance with a second preferred embodiment of the present invention; and

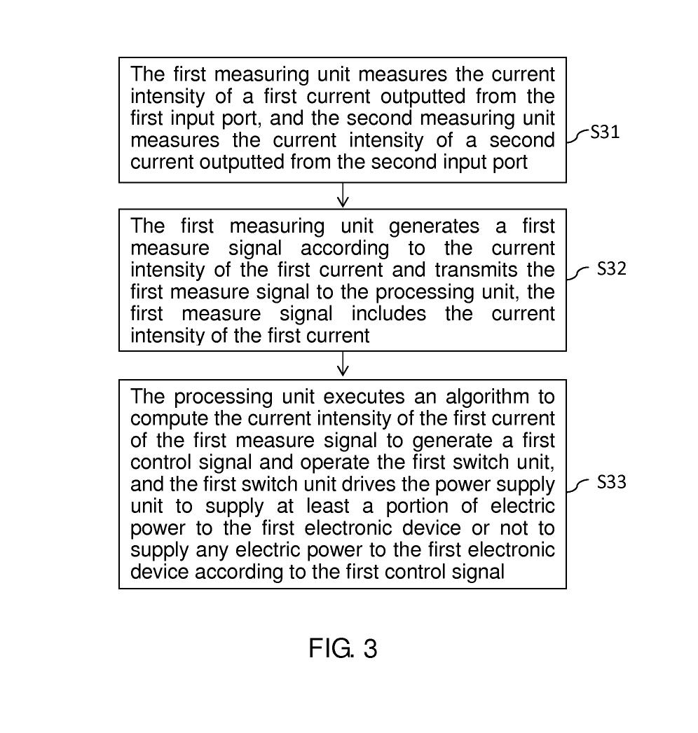

FIG. 3 is a flow chart of a power management method in accordance with a preferred embodiment of the present invention.

### DETAILED DESCRIPTION

The objects, characteristics and effects of the present invention will become apparent with the detailed description of the preferred embodiments and the illustration of related drawings as follows.

With reference to FIG. 1 for a schematic block diagram of a hub in accordance with a first preferred embodiment of the present invention, the hub 10 is connected to a power supply unit 2, a first electronic device 4, a second electronic device 6 and a server 8. In this preferred embodiment, the power supply unit 2 has a specification of electric power with an operating voltage V and a maximum output current intensity Imax, and the maximum electric power P supplied by the power supply unit 2 is the product of the operating voltage V and the maximum output current intensity Imax. The server 8 and the hub 10 can transmit data DA bi-directionally.

The hub 10 has a first connecting module 12, a second connecting module 14 and a processing unit 16.

The first connecting module 12 comprises a first input port 122, a first switch unit 124 and a first measuring unit 126. The first input port 122 comprises a power terminal 1222 and a data terminal 1224. The power terminal 1222 is connected to the power supply unit 2 for generating a first current I₁. The product of the first current I₁ and the operating voltage V is equal to a first electric power P₁, and the first electric power P₁ is equal to at least a portion of the electric power P. The data terminal 1224 is connected to the server 8 for transmitting the data DA.

The first switch unit 124 comprises a first input terminal 1242, a first control terminal 1244 and a first output terminal 1246. The first input terminal 1242 is connected to the power terminal 1222, and the first input terminal 1242 has the first electric power P₁. The first control terminal 1244 receives a first control signal CS₁ to change a short circuit status or an OFF status between the first input terminal 1242 and the first output terminal 1246.

In this preferred embodiment, the short circuit status refers to the status of the first input terminal 1242 being connected to the first output terminal 1246, and the first electric power P₁ is supplied to the first output terminal 1246; and the OFF status refers to the status of the first input terminal 1242 being disconnected from the first output terminal 1246, so that the first electric power P₁ cannot be supplied to the first output terminal 1246.

The first output terminal 1246 complies with a communication port protocol selected from the group of FireWire (IEEE 1394), universal serial bus (USB), micro universal serial bus (Micro USB), mini universal serial bus (Mini USB) and Apple 30 pins.

The first measuring unit 126 is connected to the power terminal 1222. The first measuring unit 146 is provided for measuring the current intensity of the first current I₁ outputted from the power terminal 1222 to generate a first measure signal MS₁ corresponding to the current intensity.

For example, the first measuring unit 126 comprises a resistor (not shown in the figure) and a current sensor (not shown in the figure). A terminal of the resistor is connected to the power terminal 1222 and the other terminal of the resistor is connected to the first input terminal 1242. The current sensor and the resistor are connected in parallel to each other. The current sensor senses the first current I₁ passing through the resistor to generate the first measure signal MS₁.

The second connecting module 14 comprises a second input port 142, a second switch unit 144 and a second measuring unit 146. The second input port 142 has a power terminal 1422 and a data terminal 1424. The power terminal 1422 is connected to the power supply unit 2 for generating a second current I₂. The product of the second current I₂ and the operating voltage V is equal to a second electric power P₂. The second electric power P₂ is equal to the difference of the electric power P and the first electric power P₁. The data terminal 1424 is connected to the server 8 for transmitting the data DA.

The second switch unit 144 includes a second input terminal 1442, a second control terminal 1444 and a second output terminal 1446. The second switch unit 144 is connected to a second control signal CS₂ to change a short circuit status or an OFF status between the second input terminal 1442 and the second output terminal 1446. The same description of the short circuit status or the OFF status of first switch unit 124 can be applied for the second switch unit 144.

The same measurement method of the first measuring unit 126 can be applied to the second measuring unit 146. In other words, the second measuring unit 146 generates a second measure signal MS₂ corresponding to the measured current intensity of the second current I₂ outputted from the power terminal 1422.

The processing unit 16 is connected to the first measuring unit 126, the second measuring unit 146, the first control terminal 1244 and the second control terminal 1444. The processing unit 16 receives the first measure signal MS₁ and the second measure signal MS₂. The processing unit 18 executes an algorithm (not shown in the figure) to compute the first measure signal MS₁ and the second measure signal MS₂ to generate the first control signal CS₁ corresponding to the first measure signal MS₁ and the second control signal CS₂ corresponding to the second measure signal MS₂. The processing unit 16 transmits the first control signal CS₁ to the first control terminal 1244 and the second control signal CS₂ to the second control terminal 1444.

In this preferred embodiment, the algorithm computes the first measuring signal MS₁ and the second control signal CS₂ by the following two methods, and it is noteworthy that the algorithm determines whether the first electronic device 4 or the second electronic device 6 is connected to any one of the output terminals 1246, 1446 first. In this preferred embodiment, the first electronic device 4 is connected to the first output terminal 1246 before the second electronic device 6 is connected. Therefore, the algorithm computes the first current I₁ of the first electronic device 4 generated at the first connecting module 12 first.

In the first method, the algorithm defines a first reference current intensity (not shown in the figure). The processing unit executes the algorithm to compare the current intensity of the first current I₁ with the first reference current intensity. If the current intensity of the first current I₁ is greater than or equal to the first reference current intensity, then the processing unit 16 will generate and transmit the first control signal CS₁ to the second control terminal 1444, such that the first electric power P₁ cannot be supplied to the first electronic device 4.

In the second method, the algorithm defines a second reference current intensity (not shown in the figure). The processing unit executes the algorithm to subtract the current intensity of the first current I₁ from the current intensity of the maximum output current Imax. If remaining current intensity of the maximum output current Imax is greater than or equal to the second reference current intensity, then the processing unit 18 will generate and transmit the second control signal CS₂ to the second switch unit 164, such that the power supply unit 2 will supply the second electric power P₂ to the second electronic device.

With reference to FIG. 2 for a schematic block diagram of a hub in accordance with the second preferred embodiment of the present invention, the hub 10′ further comprises a chip unit 18 in addition to the first connecting module 12, the second connecting module 14 and the processing unit 16 as described in the first preferred embodiment.

The chip unit 18 is connected to the first output terminal 1246, the second output terminal 1446 and the processing unit 18. The chip unit 18 detects whether or not the first output terminal 1246 is connected to the first electronic device 4 to generate a first detect signal DS₁ and transmit the first detect signal DS₁ to the processing unit 16. The method for the chip unit 18 to detect the first output terminal 1246 can be applied for detecting whether or not the second output terminal 1446 is connected to the second electronic device 6 to generate a second detect signal DS₂.

The processing unit 16 executes an algorithm to compute the first measure signal MS₁, the second measure signal MS₂, the first detect signal DS₁ and the second detect signal DS₂ to generate the first control signal CS₁ and the second control signal CS₂.

In addition to the aforementioned first and second methods as described in the first preferred embodiment, there is also a third method of the algorithm, wherein the algorithm defines a queue (not shown in the figure). The queue records the sequence of the first switch unit 124 being connected to the first electronic device 4 and the second switch unit 144 being connected to the second electronic device 6. In this preferred embodiment, the first switch unit 124 is connected to the first electronic device 4 before the second switch unit 144 is connected to the second electronic device 6. Therefore, the first electronic device 4 is recorded to be in the first order of the queue and the second electronic device 6 is recorded to be in the second order of the queue.

The processing unit 18 supplies the first electric power P₁ of the power supply unit 2 to the first electronic device 4 which is in the first order of the queue according to the queue.

In another preferred embodiment, the processing unit 18 further executes another algorithm to determine whether the remaining electric power P of the power supply unit 2 is greater than or equal to the second electric power P₂. If yes, then the power supply unit 2 will supply the second electric power P₂ to the second electronic device 6, or else the power supply unit 2 will not be able to supply the second electric power P₂ to the second electronic device 6 until the first electronic device 4 is not connected to the first switch unit 124, or the remaining electric power P is greater than or equal to the second electric power P₂.

With reference to FIG. 3 for a flow chart of a power management method in accordance with a preferred embodiment of the present invention, the power management method is applied to a hub such as the hub 10 as described in the first preferred embodiment or the hub 10′ as described in the second preferred embodiment. For example, the first switch unit 124 is connected to the first electronic device 4, and the second switch unit 144 is connected to the second electronic device 6. This arrangement is used as an example for illustrating the invention.

The power management method comprises the following steps:

S31: The first measuring unit measures the current intensity of a first current outputted from the first input port, and the second measuring unit measures the current intensity of a second current outputted from the second input port to confirm that the first switch unit is connected to the first electronic device and the second switch unit is not connected to the second electronic device.

S32: The first measuring unit generates a first measure signal according to the current intensity of the first current and transmits the first measure signal to the processing unit. The first measure signal includes the current intensity of the first current.

S33: The processing unit executes an algorithm to compute the current intensity of the first current of the first measure signal to generate a first control signal and operate the first switch unit, and the first switch unit drives the power supply unit to supply at least a portion of electric power to the first electronic device or not to supply any electric power to the first electronic device according to the first control signal.

It is noteworthy that the algorithm can reference the three methods as described in the first and second preferred embodiments, and thus they will not be repeated.

While the invention has been described by means of specific embodiments, numerous modifications and variations could be made thereto by those skilled in the art without departing from the scope and spirit of the invention set forth in the claims.

What is claimed is:

1. A hub, connected to a power supply unit, a server and at least one electronic device, comprising:
a plurality of connecting modules, each of the connecting modules comprising:
an input port, having a power terminal and a data terminal, and the power terminal being connected to the power supply unit to receive electric power, and the data terminal being connected to the server to transmit data;
a switch unit, having an input terminal, a control terminal and an output terminal, and the input terminal being connected to the power terminal, and the control terminal receiving a control signal to change a short circuit status or an OFF status between the input terminal and the output terminal; and
a measuring unit, connected to the power terminal, for measuring a current intensity of a current outputted from the power terminal to generate a measure signal corresponding to the current intensity;
a processing unit, connected to the measuring unit and the control terminal of each of the connecting modules, for receiving the measure signal, executing an algorithm to compute the measure signal, generating the control signal corresponding to the measure signal, and transmitting the control signal to the control terminal.

2. The hub of claim 1, further comprising a chip unit connected to the processing unit and the output terminal of each of the connecting modules, for detecting whether or not the output terminal of each of the connecting modules is connected to the electronic device to generate a detect signal, and outputting the detect signal to the processing unit, and the processing unit executing another algorithm to compute the measure signal and the detect signal to generate the control signal.

3. The hub of claim 1, wherein the measuring unit comprises a resistor and a current sensor, and a terminal of the resistor is connected to the power terminal and another end of the resistor is connected to the input terminal, and the current sensor and the resistor are connected in parallel, and the current sensor senses the current passing through the resistor to generate the measure signal.

4. The hub of claim 1, wherein the output terminal complies with a communication port protocol selected from the collection of FireWire (IEEE 1394), universal serial bus, micro universal serial bus (Micro USB), mini universal serial bus (Mini USB) and Apple 30 pins.

5. A power management method, applied to a hub connected to a power supply unit and a first electronic device, and the power supply unit being provided for supplying electric power, and the hub comprising a first input port, a second input port, a first switch unit, a second switch unit, a first measuring unit, a second measuring unit and a processing unit, and each of the first input port and the second input port being connected to the power supply unit, and the first switch unit being connected to the first input port and the first electronic device, and the second switch unit being connected to the second input port, and the first measuring unit being connected to the first input port and the processing unit, and the second measuring unit being connected to the second input port and the processing unit, and the power management method comprising the steps of:
the first measuring unit measuring the current intensity of a first current outputted from the first input port, and the second measuring unit measuring the current intensity of a second current outputted from the second input port to confirm that the first switch unit is connected to the first electronic device and the second switch unit is not connected to the second electronic device;
the first measuring unit generating a first measure signal according to the current intensity of the first current, and transmitting the first measure signal to the processing unit, wherein the first measure signal includes the current intensity of the first current; and
the processing unit executing an algorithm to compute the current intensity of the first current of the first measure signal to generate a first control signal to control the first switch unit, and the first switch unit driving the power supply unit to supply at least a portion of electric power to the first electronic device or not to supply any electric power of the power supply unit to the first electronic device according to the first control signal.

6. The power management method of claim 5, wherein the algorithm defines a queue, and the queue records the sequence of connecting the first switch unit to the first electronic device and the second switch unit to a second electronic device, and the processing unit supplies at least a portion of the electric power from the power supply unit to the first electronic device or the second electronic device with an earlier order in the queue.

7. The power management method of claim 6, wherein the algorithm defines a first reference current intensity, and the processing unit executes the algorithm to compare the current intensity of the first current with the first reference current intensity, and the processing unit generates the first control signal to the first switch unit such that the electric power of the power supply unit cannot be supplied to the first electronic device, if the current intensity of the first current is not smaller than the first reference current intensity.

8. The power management method of claim 6, wherein the algorithm defines a second reference current intensity, and the processing unit executes the algorithm to subtract the current intensity of the first current from the current intensity of the maximum output current, and the power supply unit supplies the remaining electric power to the second electronic device if the remaining current intensity of the maximum output current is not smaller than the second reference current intensity.
